(19) United States
(12) Patent Application Publication
(10) Pub. No.: US 2014/0192104 A1
(43) Pub. Date: Jul. 10, 2014

(54) IMAGE FORMING APPARATUS AND IMAGE FORMING METHOD

(71) Applicant: Canon Kabushiki Kaisha, Tokyo (JP)

(72) Inventors: Noboru Toyama, Kawasaki-shi (JP); Akira Morita, Kawasaki-shi (JP)

(73) Assignee: CANON KABUSHIKI KAISHA, Tokyo (JP)

(21) Appl. No.: 14/146,957

(22) Filed: Jan. 3, 2014

(30) Foreign Application Priority Data
Jan. 8, 2013 (JP) 2013-000966

(51) Int. Cl. B41J 2/01

(52) U.S. Cl. CPC G03G 15/1605; G03G 13/16
USPC 347/1

(57) ABSTRACT

An image forming apparatus forms an image on a recording medium by forming a raw image on an intermediate transfer member with a liquid ink containing a coloring material and transferring the raw image onto the recording medium. The apparatus has an applicator unit for applying a reactive liquid onto the surface layer of the intermediate transfer member prior to the formation of the raw image. The reactive liquid urges the coloring material in the liquid ink to coagulate. The apparatus further has an adjustment unit for adjusting the thickness of the raw image according to the surface roughness of the recording medium.

### BACKGROUND OF THE INVENTION

1. Field of the Invention

The present invention relates to an image forming apparatus for and an image forming method of transferring a raw image formed on an intermediate transfer member, onto a recording medium.

2. Description of the Related Art

Ink jet image forming apparatus designed to eject liquid (ink) from a recording head have been and are broadly utilized not only for consumer applications but also for industrial applications. An ink jet recording system can form an image instantaneously on a recording medium to obtain a desired printed product because it neither needs any form plate, which is necessary for conventional printing systems such as offset printing, nor requires any lead time. Ink jet recording apparatus have advantageous features as pointed out above and hence can easily meet users' demands for small lot productions of a variety of printed products with a short delivery time.

How ink bleeds and to what extent the ink that penetrates into a recording medium subsequently spreads vary depending on the material, the thickness and the surface condition of the recording medium in the ink jet image forming apparatus that is being operated and they significantly affect the printing quality of the obtained printed product. Therefore, the conditions in which an ink jet image forming apparatus is operated to eject ink have to be controlled according to the material, the thickness and the surface condition of the recording medium being employed in the apparatus.

Japanese Patent Application Laid-Open No. 2002-340518 discloses an image forming apparatus that is designed to measure the surface roughness of a recording medium by means of a measuring instrument (surface property identifier) and control the fixing temperature of the fixing means of the apparatus for fixing an image on a recording medium and the rate of ink ejection of the recording head (ink ejection type image forming means) of the apparatus according to the measured surface roughness. Such an image forming apparatus selects a low fixing temperature and suppresses the rate of ink ejection for forming an image when the recording medium is a smooth one so that it can minimize ink bleeding into unnecessary areas on the recording medium and save ink accordingly. Conversely, when the recording medium is a one having a rough surface, it selects a high fixing temperature and a raised rate of ink ejection to accommodate the penetration of ink into lower layers of the recording medium so that problems such as production of a pale image on the recording medium may hardly occur.

Transfer type ink jet image forming apparatus have been proposed as an alternative technique of minimizing ink bleeding and production of pale images that may arise depending on the surface condition of recording medium. Japanese Patent Application Laid-Open No. H06-040025 discloses a transfer type ink jet image forming apparatus designed to form an image on an intermediate transfer member (transfer medium) by means of ink droplets ejected from its recording head and then transfer a viscous ink image onto a recording medium after removing the penetrant components of the solvent from the ink image. The viscous ink image is formed by the coloring solid ingredient(s) and the non-penetrant components in the remaining ink solvent. Such an image forming apparatus can transfer a high-quality image that is free from unnecessary penetration of ink and image distortions by using low pressure because the ink image on the intermediate transfer member is transferred onto the recording medium while it is being held in an appropriately viscous condition.

### SUMMARY OF THE INVENTION

An image that is formed on a recording medium can effectively be held free from ink bleeding and paling of the image by controlling the viscosity of the ink employed to print the image. However, according to the invention that is disclosed in the above-cited Japanese Patent Application Laid-Open No. 2002-340518, the viscosity of the ink that is being employed to print an image being formed on a recording medium is controlled only by adjusting the rate of ink ejection. When the surface of the recording medium is a smooth one, the rate of ink ejection needs to be suppressed in order to suppress ink bleeding on the recording medium. However, with the techniques of high-quality image printing that has been developed in recent years, the rate of ink ejection needs to be raised as much as possible in order to form a high definition image. In other words, there can arise a problem of producing a pale image when the rate of ink ejection is suppressed in an operation of printing a high-quality high-definition image.

An excellently transferred image can be obtained by using an image forming apparatus described in the above-cited Japanese Patent Application Laid-Open No. H06-040025 with a recording medium having a relatively smooth surface because a sufficient contact area is secured between the image formed by viscous ink on the intermediate transfer member of the apparatus and the recording medium. However, when a recording medium having large undulations on the surface (a rough surface) such as wood free paper for printing is employed, the contact area between the image formed by viscous ink on the intermediate transfer member of the apparatus and the recording medium is remarkably reduced if compared with an instance where a recording medium having a smooth surface is employed. Thus, as a matter of course, there arises an apprehension that the ink on the intermediate transfer member may only poorly be transferred onto the recording medium.

Additionally, when an operation of transferring an ink image onto a recording medium is conducted at high speed, the contact time between the intermediate transfer member and the recording medium is inevitably curtailed. In such an instance, a poor performance may likely be observed for the operation of transferring the ink image onto the recording medium particularly when wood free paper having large undulations on the surface is employed because not only the contact area between the viscous ink image on the intermediate transfer member and the recording medium is small but also the contact time is curtailed.

In view of the above-identified problems, it is therefore an object of the present invention is to dissolve the problems by providing an image forming apparatus whose performance of transferring ink onto a recording medium is not degraded regardless of the surface condition of the recording medium and even when an image is transferred onto the recording medium at high speed.

The above-described object of the present invention is achieved by providing an image forming apparatus for forming an image on a recording surface of a recording medium, the apparatus comprising: a recording head for ejecting a liquid ink containing a coloring material; an intermediate transfer member having a surface layer for forming a raw image thereon by means of the liquid ink ejected from the recording head; an applicator unit for applying a reactive liquid for urging the coloring material in the liquid ink to coagulate, onto the surface layer of the intermediate transfer member prior to the formation of the raw image by the liquid ink; a transfer unit for transferring the raw image formed on the surface layer of the intermediate transfer member onto the recording surface of the recording medium at a transfer point where the recording medium are conveyed and pressed to the intermediate transfer member; and an adjustment unit for executing a process of adjusting a thickness of the raw image on the surface layer at an upstream side of the transfer point according to a surface roughness of the recording surface of the recording medium.

In another aspect of the present invention, there is provided a method of forming an image on a recording surface of a recording medium by transferring a raw image formed on a surface layer of an intermediate transfer member by means of a liquid ink containing a coloring material, onto the recording surface of the recording medium, the method comprising: a step of applying a reactive liquid for urging the coloring material in the liquid ink to coagulate, onto the surface layer of the intermediate transfer member; a step of ejecting the liquid ink onto the surface layer of the intermediate transfer member carrying the reactive liquid applied thereto to form the raw image; and a step of transferring the raw image formed on the surface layer of the intermediate transfer member onto the recording surface of the recording medium; the method further comprising: a step of executing a process of adjusting a thickness of the raw image formed on the surface layer of the intermediate transfer member according to a surface roughness of the recording surface of the recording medium.

Further features of the present invention will become apparent from the following description of exemplary embodiments with reference to the attached drawing.

### BRIEF DESCRIPTION OF THE DRAWINGS

FIG. 1 is a schematic illustration of the first embodiment of image forming apparatus according to the present invention, representing the arrangement for transferring an image onto a recording medium by means of the components thereof illustrated in cross section;

FIG. 2 is a flowchart of the step for forming an image on a recording medium by means of an image forming apparatus according to the present invention;

FIG. 3 is a schematic illustration of the second embodiment of image forming apparatus according to the present invention, representing the arrangement for transferring an image onto a recording medium by means of the components thereof illustrated in cross section; and

FIG. 4 is a schematic illustration of the third embodiment of image forming apparatus according to the present invention, representing the arrangement for transferring an image onto a recording medium by means of the components thereof illustrated in cross section.

### DESCRIPTION OF THE EMBODIMENTS

### Embodiments

Now, preferred embodiments of the present invention will be described below in detail by referring to the accompanying drawings.

### First Embodiment

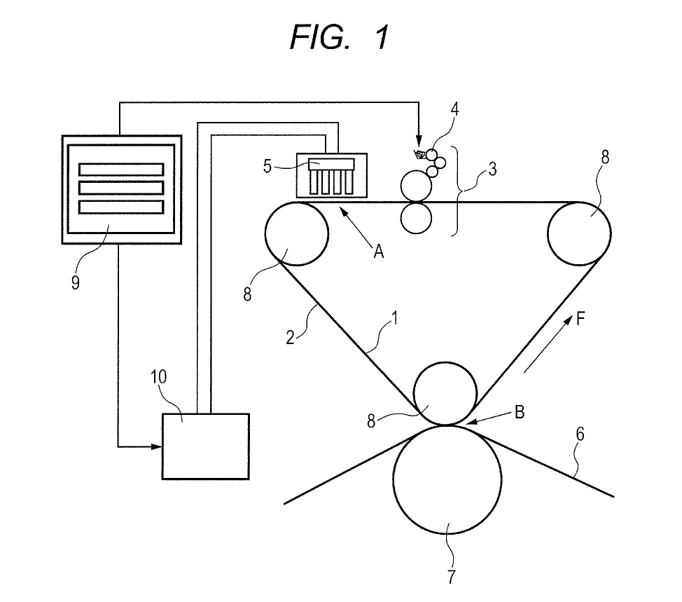

FIG. 1 is a schematic illustration of the first embodiment of image forming apparatus according to the present invention, representing the arrangement for transferring the image formed on the intermediate transfer member thereof onto a recording medium by means of the components illustrated in cross section. Note that, for the following description, the mass of liquid formed on the surface layer of the intermediate transfer member of an image forming apparatus according to the present invention so as to be transferred onto a recording medium is defined as a raw image, whereas the mass of liquid formed on the recording surface of a recording medium according to the image data input to the image forming apparatus is defined as a final image. Generally, a raw image is a mirror image of the final image that is formed from the raw image.

The image forming apparatus comprises an intermediate transfer belt 1 that is an intermediate transfer member for transferring a raw image onto the recording surface of a recording medium 6 and a recording head 5 located right above the surface layer 2 of the intermediate transfer belt 1 so as to eject ink (liquid) onto the surface layer 2 of the intermediate transfer belt and form a raw image. The surface layer 2 of the intermediate transfer belt 1 is formed by means of a suitable material, which may be metal, polymer, rubber, ceramic or the like. The surface layer 2 of the intermediate transfer belt 1 of this embodiment is made of a material obtained by treating the surface of a water-repellent base member so as to endow it with hydrophilicity. Silicone (trade name) rubber, fluorine rubber or the like is employed for the water-repellent base member and a corona treatment, a flame treatment, an irradiation of active energy rays, a plasma treatment or the like is employed for the surface treatment of the water-repellent base member. At the time of the surface treatment, gas such as oxygen gas may be used simultaneously to raise the effect of the treatment.

The intermediate transfer belt 1 is driven to move round in the moving direction F by means of a plurality of revolving rollers 8 with its surface layer 2 facing the outside. An applicator unit 3 is arranged to apply a reactive liquid (agent) 4 onto the surface layer 2 of the intermediate transfer belt 1 at a position upstream relative to image forming point A, where an image is formed on the surface layer 2 of the intermediate transfer belt 1 by the recording head 5, in terms of the moving direction of the intermediate transfer belt 1. The applicator unit 3 is designed to apply a reactive liquid 4 onto the surface layer 2 of the intermediate transfer belt 1 via contact application such as wire bar coating or via non-contact application such as spray coating or application of liquid droplets by means of an ink jet head. Although the scope of applicability may be limited, a reactive liquid 4 can be applied without any problem from the view point of application characteristics via spin coating, pull up application or the use of an air knife. Any of the above listed application techniques may be combined for the applicator unit 3 to apply a reactive liquid 4 onto the surface layer 2 of the intermediate transfer belt 1.

As will be described hereinafter, an ink density adjustment unit 10 for adjusting the ink density and supplying ink to the recording head 5 is connected to the recording head 5 as an exemplar adjustment unit for adjusting the thickness of a raw image. The ink density adjustment unit 10 is a device for adjusting the density of at least one of the ingredients of the ink to be used for forming a raw image on the intermediate transfer belt 1 other than the coloring material according to the information it receives on the surface condition of the recording medium 6 to be used for forming an image thereon without significantly altering the density of the coloring material and then supplying ink that is optimally adapted to the surface condition of the recording medium 6. The one of the ingredients other than the coloring material of the ink whose density is to be adjusted may be water-soluble polymer, polymer emulsion, a solvent or water. For the purpose of the present invention, any applicable polymer material can be used as water-soluble polymer or polymer emulsion without limitations so long as it is compatible with the ingredients of ink, which will be described hereinafter.

Referring to FIG. 1, the recording medium 6 is being conveyed toward transfer point B, where the raw image on the surface layer 2 of the intermediate transfer belt 1 is transferred onto the recording surface of the recording medium 6, by a conveyance roller (not illustrated). As an example of transfer unit, a pressure roller 7 is arranged at the transfer point B, where the raw image on the surface layer 2 of the intermediate transfer belt 1 transferred onto the recording surface of the recording medium 6, so as to press the recording medium 6 against the intermediate transfer belt 1. At the transfer point B, the recording medium 6 and the intermediate transfer belt 1 are pinched between the pressure roller 7 and the revolving roller 8 that drives the intermediate transfer belt 1 to rotate.

The surface roughness of the recording medium 6 where a final image is to be formed is recognized by the ink density adjustment unit 10 as the type of the recording medium 6 is input to it by the user of the image forming apparatus by way of touch panel 9 or the like that is mounted in the image forming apparatus. The touch panel 9 is arranged outside the image forming apparatus and the surface condition of the recording medium and, based on the input information, the optimum density of one of the ingredients of the ink to be used for forming a raw image other than the coloring material of the ink are retrieved from a memory (not illustrated) arranged in the inside of the image forming apparatus. Note that the surface condition of the recording medium 6 that is retrieved may typically be expressed by arithmetic average roughness Ra, ten-point average roughness Rz or the like that is defined in JIS B 0601 (1994).

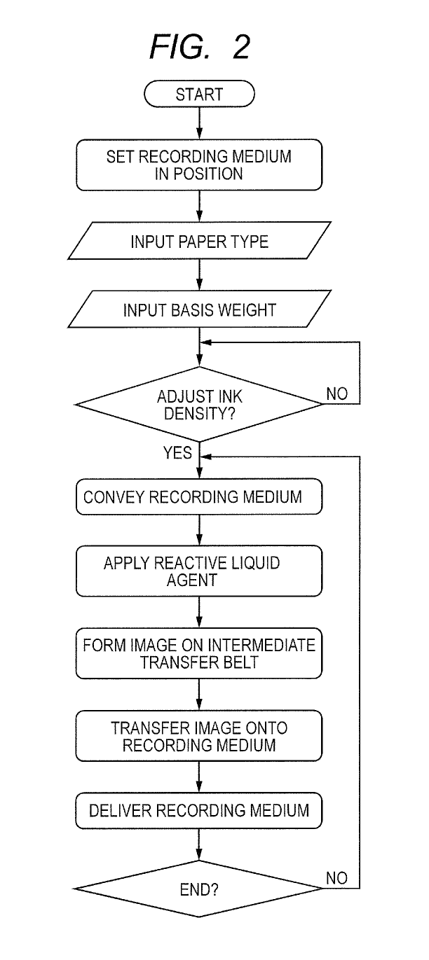

Now, the flow of the process by means of which the image forming apparatus forms a final image on a recording medium 6 will be described below by referring to FIG. 2.

To begin with, the user of the image forming apparatus sets a recording medium 6 on which the user wants to form a final image in position in a paper feeding cassette (not illustrated). As the recording medium 6 is set in position in the paper feeding cassette, the user inputs the type of the recording medium 6 that is set in the paper feeding cassette by way of the touch panel 9 arranged outside the image forming apparatus. As the operation of inputting the type of the recording medium 6 is over, the user then inputs the basis weight of the recording medium 6 also by way of the touch panel 9. The basis weight of the recording medium 6 needs to be input because the surface profile such as the surface undulations may vary from a recording medium to a recording medium depending on the basis weight among recording mediums of the same type.

As the type and the basis weight of the recording medium 6 are input, the surface condition, which may be expressed typically by the arithmetic average roughness Ra of the surface, is retrieved from the memory (not illustrated). Then, the ink density adjustment unit 10 adjusts at least one of the ingredients of the ink other than the coloring material according to the retrieved arithmetic average roughness Ra. Note that each of the measured values of arithmetic average roughness Ra that are cited hereinafter is obtained from the data acquired by observing a square of 280 μm² of the corresponding recording medium through a laser microscope VK9710 available from Keyence with a magnitude of 50.

When the ingredient other than the coloring material that is to be adjusted is water-soluble polymer, the ink density adjustment unit 10 adjusts the ink density by mixing condensed ink with a condensed water-soluble polymer solution. Condensed ink as used herein refers to ink obtained by removing an appropriate quantity of water and/or solvent from ink that can optimally be used for a recording medium 6 whose surface represents an arithmetic average roughness Ra of not greater than 0.7 μm. On the other hand, condensed water-soluble polymer as used herein refers to a solution containing at least water-soluble polymer. When condensed ink is prepared by using water-soluble polymer as dispersed polymer, the water-soluble polymer contained in the solution is preferably the same as the dispersed polymer.

When the surface condition of the recording medium 6 is a smooth one, ink hardly penetrates into lower layers of the recording medium 6. Then, ink bleeding can easily occur when ink is ejected at an excessively high rate so that the rate of ink ejection is suppressed to a low level. Therefore, a large value is selected for the density of the pigment in the ink that is to be used for forming an image so that the density of the final image to be formed may not fall if ink is ejected at a low rate. To the contrary, when the surface of the recording medium 6 represents large undulations, ink can easily penetrate into lower layers of the recording medium 6 so that the rate of ink ejection is so controlled as to represent a large value. Therefore, a small value is selected for the density of the pigment in the ink that is to be used for forming an image so that the density of the final image to be formed may not become too high if ink is ejected at a high rate.

While the density of the water-soluble polymer in the condensed water-soluble polymer solution may be determined appropriately, the density needs to be high enough and satisfy the requirements of the ink obtained after adding the condensed water-soluble polymer solution. The mixing ratio of condensed ink and condensed water-soluble polymer solution is determined as a function of the arithmetic average roughness Ra of the recording medium 6. For example, in an instance of ink one of the ingredients of which is to be adjusted by means of water-soluble polymer similar to dispersed polymer, condensed ink and a condensed water-soluble polymer solution may be mixed such that the ratio of the pigment and the water-soluble polymer (which may include dispersed polymer) after adjusting the ingredient fall within the relevant one of the ranges listed below.

surface condition—arithmetic average roughness Ra is not greater than 0.7 μm: 1:0.5 to 1.5

surface condition—arithmetic average roughness Ra is between 0.7 μm and 2.0 μm: 1:1.5 to 2.5

surface condition—arithmetic average roughness Ra is not smaller than 2.0 μm: 1:2.5 to 5.0

When mixing condensed ink and a condensed water-soluble polymer solution, water and/or a solvent may be added whenever necessary.

The above-listed values of arithmetic average roughness Ra are represented only as examples that can be used for the purpose of the present invention. In other words, the value of Ra may vary depending on the measuring means, the measuring method and other factors. Similarly, the ratios of the pigment to the polymer listed above are subject to changes depending on the type of pigment and the type of polymer to be used and their molecular weights. In other words, the range of values for the optimal arithmetic average roughness Ra and the corresponding range of values for the ratio of the pigment to the water-soluble polymer need to be determined appropriately.

As the ink to be used for forming an image is adjusted in the above-described manner so as to match the arithmetic average roughness Ra of the recording medium 6, the conveyance roller (not illustrated) starts an operation of conveying the recording medium 6 from the paper feeding cassette toward the transfer point B. At the same time, the plurality of revolving rollers 8 starts driving the intermediate transfer belt 1 to move round. After the reactive liquid 4 is applied to the surface layer 2 of the intermediate transfer belt 1 by the application unit 3, the recording head 5 ejects the ink supplied from the ink density adjustment unit 10 to form a raw image on the surface layer 2 of the intermediate transfer belt 1. Note that the raw image is a mirror image of the final image to be formed according to the image data input to the image forming apparatus in view of that the raw image is transferred onto the recording medium 6. As the ink ejected from the recording head 5 is forced to contact the reactive liquid 4 that has been applied to the surface layer 2 of the intermediate transfer belt 1, a coagulation reaction takes place instantaneously to reduce the fluidity of the coloring material. As pointed out above, the extent of coagulation of the ink changes as the density of at least one of the ingredients of the ink other than the coloring material is adjusted to by turn adjust the thickness of the raw image formed on the surface layer 2 of the intermediate transfer belt 1.

The raw image on the surface layer 2 of the intermediate transfer belt 1 is conveyed to the transfer point B located between the pressure roller 7 and the related one of the plurality of revolving rollers 8 in exact timing with that the recording medium 6 that is being conveyed gets to the transfer point B located between the pressure roller 7 and the related one of the plurality of revolving rollers 8. At the transfer point B, the recording medium 6 is pressed against the intermediate transfer belt 1 by the pressure roller 7 to force the recording surface of the recording medium 6 to contact the surface layer 2 of the intermediate transfer belt 1 that carries the raw image formed thereon. Consequently, a final image is formed on the recording surface of the recording medium 6. At this time, the transfer pressure that is applied to the recording medium 6 by the pressure roller 7 is raised in proportion to the value of the arithmetic average roughness Ra so as to increase the contact area of the recording medium 6 and the intermediate transfer belt 1 and improve the image transfer performance.

The pressure roller 7 may be heated when it presses the recording medium 6 against the intermediate transfer belt 1. The temperature to which the pressure roller 7 is heated is preferably not lower than the glass transition temperature of the water-soluble polymer contained in the ink or the temperature at which the polymer emulsion contained in the ink turns into film (membranation temperature?). Similarly, the temperature to which the pressure roller 7 is heated is preferably not lower than the glass transition temperature of the water-soluble polymer contained in the reactive liquid or the temperature at which the polymer emulsion contained in the reactive liquid turns into film (membranation temperature?). Then, as the transfer temperature rises, the performance of transferring the image onto the recording medium 6 is improved because the raw image on the intermediate transfer belt 1 becomes softened to provide an effect of improving the effect of tacking the raw image to the recording medium and also the effect of making the raw image tightly adhere to the recording medium 6. To provide an effect of improving the image transfer performance by heating the raw image, the intermediate transfer belt 1 itself may be heated before it approaches the transfer point B to by turn heat the raw image on the intermediate transfer belt 1 instead of heating the pressure roller 7.

The recording medium 6 on which the final image is formed as a result of image transfer from the intermediate transfer belt 1 then passes and leaves the transfer point B and is conveyed further to a paper delivery cassette (not illustrated) by a paper delivery roller (not illustrated). The intermediate transfer belt 1 from which the image has been transferred onto the recording medium 6 is then made ready for the next printing cycle. Then, the image forming apparatus stops operating.

A final image is formed on the recording medium 6 by way of the above-described steps.

Now, the reactive liquid 4 that is employed for the purpose of the present invention will be described below.

The reactive liquid that is employed for the purpose of the present invention may be appropriately selected according to the type of ink to be used for forming an image by the image forming apparatus. For example, a polymer coagulant can effectively be employed for dye inks, whereas metal ions can effectively be employed for pigment inks that contain micro particles in a dispersed state. In some instances, metal ions and a polymer coagulant may be used in combination as image solidifying component of a reactive liquid 4. Such a reactive liquid 4 can suitable be used for inks containing a dye and a pigment of an equivalent color and inks containing a mixture of a dye and white or transparent micro particles that do not significantly affect the color of the dye.

Polymer coagulants that can be used for the reactive liquid 4 include cationic polymer coagulants, anionic polymer coagulants, nonionic polymer coagulants and ampho-ionic polymer coagulants. On the other hand, metal ions that can be used for the reactive liquid 4 include divalent metal ions such as Ca²⁺, Cu²⁺, Ni²⁺, Mg²⁺ and Zn²⁺ and trivalent metal ions such as Fe³⁺ and Al³⁺. The liquid that contains such metal ions is preferably applied as metal salt aqueous solution. If such is the case, anionic ions of metal salts that can be used include Cl⁻, No³⁻, So4²⁻, I⁻, Br⁻, ClO³⁻ and RCOO⁻ (where R is an alkyl group).

A material having an inverted property relative to the ink to be used is employed for the reactive liquid 4. For example, if the ink is anionic or alkaline, a cationic material or an acidic material, whichever appropriate, is employed for the reactive liquid 4 because of their inverted properties. Additionally, water-soluble polymer, polymer emulsion or a mixture thereof may be added to the reactive liquid 4 or a mixture thereof may be added to the ink for the purpose of improving the image transfer performance.

Now, ink to be used for forming a final image for the purpose of the present invention will be described below.

While any ink may be used without limitations for the purpose of the present invention, water-based ink containing a dye or a pigment can generally most suitably be employed. Particularly, water-based pigment ink is most suitable when a metal salt is employed for the reactive liquid 4.

Dyes that are popularly being used can also be employed without any problem for the purpose of the present invention. Examples of dyes that can be used for the purpose of the present invention include C. I Direct Blues 6, 8, 22, 34, 70, 71, 76, 78, 86, 142 and 199, C. I Acid Blues 9, 22, 40, 59, 93, 102, 104, 117, 120, 167 and 229, C. I Direct Reds 1, 4, 17, 28, 83 and 227, C. I Acid Reds 1, 4, 8, 13, 14, 15, 18, 21, 26, 35, 37, 249, 257 and 289, C, I Direct Yellows 12, 24, 26, 86, 98, 132 and 142, C. I Acid Yellows 1, 3, 4, 7, 11, 12, 13, 14, 19, 23, 25, 34, 44 and 71, C. I Food Blacks 1 and 2 and C. I Acid Blacks 2, 7, 24, 26, 31, 52, 112 and 118.

Pigments that are popularly being used can also be employed without any problem for the purpose of the present invention. Examples of pigments that can be used for the purpose of the present invention include C. I Pigment Blues 1, 2, 3, 15:3, 16 and 22, C. I Pigment Reds 5, 7, 12, 48 (Ca), 48 (Mn), 57 (Ca), 112 and 122, C. I Pigment Yellows 1, 2, 3, 13, 16 and 83, Carbon Blacks (trade names) Nos. 2300, 900, 33, 40 and 52, MAs 7 and 8, MCF 88 (available from Mitsubishi Chemical), RAVEN (trade name) 1255 (available from Columbia Chemicals), REGALs (trade names) 330R and 660R, MOGUL (trade name) (available from Cabot), Color Blacks FW1, FW18, 5170, 5150 and Printex (trade name) 35 (available from Degussa).

Pigments as listed above may be used in any mode of utilization without limitations. For example, self-dispersion type pigments, polymer-dispersion type pigments and microcapsule type pigments can be used for the purpose of the present invention. As pigment dispersant, water-soluble dispersant polymer having a weight average molecular weight between about 1,000 and about 15,000 can suitably be used. Specific examples of such dispersants include block copolymers, random copolymers and salts thereof formed by using any of styrene and derivatives thereof, vinyl naphthalene and derivatives thereof, aliphatic alcohol esters of α,β-ethylenically unsaturated carboxylic acids, acrylic acid and derivatives thereof, maleic acid and derivatives thereof, itaconic acid and derivatives thereof, fumaric acid and derivatives thereof.

Furthermore, as described above, water-soluble polymer, polymer emulsion or a mixture thereof may be added to ink for the purpose of improving the performance of transferring a raw image onto the recording medium 6.

The content ratio of the organic solvent that is contained in ink is a factor that determines the ejection property and the drying property of ink. When ink is transferred onto the recording medium 6, it contains substantially only a coloring material and a high boiling point organic solvent. Therefore, ink needs to be so designed that the content ratio of the organic solvent represents an optimum value. The organic solvent to be used for ink is preferably a water-soluble material having a high boiling point with a low vapor pressure. Examples of organic solvents that can be used for such ink include polyethylene glycol, polypropylene glycol, ethylene glycol, propylene glycol, butylene glycol, triethylene glycol, thiodiglycol, hexylene glycol, diethylene glycol, ethylene glycol monomethyl ether, diethylene glycol monomethyl ester, and glycerin. Alcohol such as ethyl alcohol or isopropyl alcohol may be added as a component for adjusting the viscosity, the surface tension and so on.

There are no particular limitations to the compounding ratio of the ingredients of ink. In other words, the compounding ratio can be adjusted appropriately within a scope that allows ink to be effectively ejected by considering the selected inkjet recording technique, the ejection force of the recording head 5, the nozzle diameter and other factors. As an example, the composition of ink may be such that it contains a coloring material by 1 to 10%, polymer by 0.1 to 10%, a solvent by 5 to 40% and a surfactant by 0.1 to 5%, water taking the balance.

### Second Embodiment

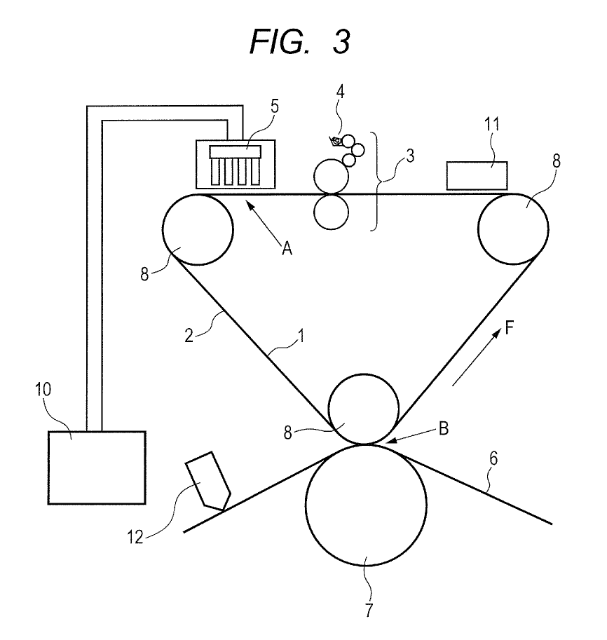

FIG. 3 is a schematic illustration of the second embodiment of image forming apparatus according to the present invention, representing the arrangement for transferring the image formed on the intermediate transfer member thereof onto a recording medium by means of the components illustrated in cross section.

The image forming apparatus of this embodiment differs from the first embodiment of image forming apparatus in that it additionally comprises a moisture removal accelerator unit 11 and a measurement unit 12.

The moisture removal accelerator unit 11 is a device for evaporating the moisture on the surface layer 2 of the intermediate transfer belt 1 after the operation of transferring a raw image onto a recording medium 6. It is arranged between the transfer point B and the point where the applicator unit 3 is located as viewed in the moving direction F of the intermediate transfer belt 1. The moisture removal accelerator unit 11 is designed to remove moisture by blowing air onto the surface layer 2 of the intermediate transfer belt 1, lowering the pressure on the surface layer 2 and/or making the surface layer 2 of the intermediate transfer belt contact with a moisture absorbing material. Alternatively, a heater for heating the intermediate transfer belt 1 itself may be provided for the purpose of moisture removal. Note that the solvent may be removed with water to a certain extent at the same time.

The measurement unit 12 is an instrument for measuring the surface roughness of the recording medium 6. It is arranged between the transfer point B where the image on the surface layer 2 of the intermediate transfer belt 1 is transferred onto the recording medium 6 and the applicator unit 3 at an upstream position as viewed in the direction in which the recording medium 6 is driven to move. The measurement unit 12 is designed to utilize the α-Step when a contact type measurement technique is adopted, whereas it is designed on the basis of the principle of confocal microscope of utilizing laser interferometry or white light interferometry when a non-contact type measurement technique is adopted. When a measurement unit 12 is provided, the user does not need to input the paper type and the basis weight by means of a touch panel.

Note, however, that a moisture removal accelerator unit 11 and a measurement unit 12 may not necessarily be provided. In other words, both or either of them may be provided only if necessary.

The configuration of the image forming apparatus and the method of forming a final image on a recording medium 6 of this embodiment are the same as those of the first embodiment and hence will not be described here repeatedly.

### Third Embodiment

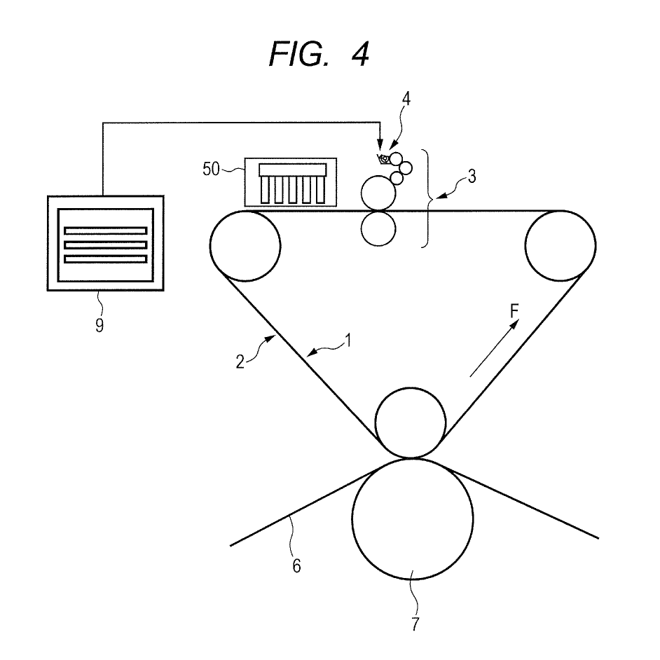

FIG. 4 is a schematic illustration of the third embodiment of image forming apparatus according to the present invention, representing the arrangement for transferring the image formed on the intermediate transfer member onto a recording medium by means of the components thereof illustrated in cross section.

The configuration of this image forming apparatus of this embodiment is the same as that of the first embodiment except that it does not comprise an ink density adjustment unit 10 and the recording head 5 of the first embodiment is replaced by recording head 50 in this embodiment. Now, the head 50 having a configuration different from the head 5 of the first embodiment and the technique of thickness adjustment of this embodiment that utilizes the surface undulations of the etching medium and liquid (transparent ink) that does not contain any coloring material will be described below.

The recording head 50 is designed to eject at least four color inks of cyan, magenta, yellow and black and a transparent ink. Additionally, the recording head 50 is so designed that it ejects transparent ink at a certain position after the application of the reactive liquid 4, between the ejections of inks of different colors or after inks of all the colors are ejected.

Transparent ink is required to contain at least a component material that reacts with the reactive liquid 4 and coagulates. Otherwise, it contains the relevant materials described above for the first embodiment.

As the type and the basis weight of the recording medium 6 to be used are input, the surface condition that may, for example, be expressed as arithmetic average roughness Ra that corresponds to the input information is retrieved from the memory of the apparatus (not illustrated).

The rate at which transparent ink is ejected is determined according to the arithmetic average roughness Ra of the recording medium 6. For example, in an instance where ink containing water-soluble polymer that is similar to dispersed polymer is employed, the image transfer performance will be improved by ejecting transparent ink in such a way that the ratio of the amount of the pigment in the ink on the intermediate transfer member to the sum of the amount of the water-soluble polymer in the ejected transparent ink and the amount of the water-soluble polymer (including dispersed polymer) in the ink on the intermediate transfer member is within the relevant one of the ranges listed below.

surface condition—arithmetic average roughness Ra not greater than 0.7 μm: 1:0.5 to 1.5

surface condition—arithmetic average roughness Ra between 0.7 μm and 2.0 μm: 1:1.5 to 2.5

surface condition—arithmetic average roughness Ra not smaller than 2.0 μm: 1:2.5 to 5.0

The ejection rate of transparent ink needs to be adjusted to satisfy the above requirement.

Then, an excellent image transfer performance can be realized due to a combined effect of the ink (image) thickness that is raised as the content ratio of solid is increased as a function of arithmetic average roughness Ra and the adhesion of ink to paper that is raised as the content ratio of polymer is increased.

While transparent ink may be ejected from the recording head 50 at a certain position after the reactive liquid 4 is applied, between the ejections of inks of different colors or after inks of all the colors are ejected to realize an improvement of the image transfer performance, preferably transparent ink is ejected after inks of all the colors are ejected from the viewpoint of improving the image transfer performance. The reason for this may be that the paper surface that receive inks of all the colors become rich of polymer to consequently improve the adhesion of ink to the paper.

Now, specific examples of forming an image by means of any of the first, second and third embodiments will be described below.

### Example 1

The compounding ratio of the condensed inks (four inks containing pigments of respective colors as coloring materials) used in this example are listed below.

pigments as listed below: 2 portions per ink black: carbon black (MCF88: available from Mitsubishi Chemical)

cyan: Pigment Blue 15:3

magenta: Pigment Red 7

yellow: Pigment Yellow 74

styrene-acrylic acid-acrylic acid ester copolymer: 2 portions

(acid value 240, weight average molecular weight 5,000)

glycerin: 10 portions

ethylene glycol: 5 portions

surfactant: 1 portion

(Acetylenol EH (trade name): available from Kawaken Fine Chemicals)

ion exchange water: 80 portions

Condensed inks are prepared with the above compounding ratio, from which only 20 portions of ion exchange water is deducted.

The recording medium 6 used in this example is Aurola Coat Paper (basis weight 127.9 g/m²) available from Nippon Paper Industries. The arithmetic average roughness of Aurola Coat Paper that is stored in advance in the memory of the apparatus is Ra=0.38 and the corresponding pigment to water-soluble polymer ratio is 1:1. Ink that is optimally adapted to Aurola Coat Paper is produced by mixing 80 grams of condensed ink 80 and 20 grams of ion exchange water according to the above ratio and agitating the mixture.

In this example, a material obtained by coating the surface of 0.4 mm PET film with silicon rubber (KE12: available from Shin-Etsu Chemical) having a rubber hardness of 40° to a thickness of 0.3 mm is employed for the base member of the surface layer 2 of the intermediate transfer belt 1. A regular repetitive pattern having lyophilic parts and lyorepellent parts is formed on the surface. To form the regular repetitive pattern, a lyophilic surface treatment is performed on the surface of the base member of the surface layer 2 by means of a parallel plate type atmospheric plasma treatment system (APT-203: available from Sekisui Chemical) to begin with and then 3% PVA aqueous solution (403: available from Kuraray) is applied to the entire surface by means of a roll coater and dried. A spot beam of an excimer laser is irradiated onto the surface that is prepared in the above-described manner to remove the PVA layer of the parts that are to become lyophilic. In this example, circles having a diameter of pm are arranged at a regular pitch of 20 μm for patterning. Subsequently, a surface reforming treatment is performed by means of the parallel plate type plasma treatment system again with the following operating conditions.

gas flow rate selected for operation; air: 1,000 cc/min

N2: 6,000 cc/min

input voltage: 230 V

frequency: 10 kHz

processing rate: 200 mm/min

Then, the reformed surface is washed with 5% aqueous solution of a surfactant (available from Nippon Unicar: silwet L77) to dissolve and remove the PVA layer that is a water-soluble film coat. Thus, only the parts irradiated with an excimer laser beam become lyophilic parts so that a regular repetitive pattern having desired lyophilic/lyorepellent parts is formed on the base member of the surface layer 2.

The intermediate transfer belt 1 is produced by bonding the base member of the surface layer 2 on which the regular repetitive pattern is formed onto a belt prepared by impregnating a strip-shaped unwoven fabric with urethane polymer.

The reactive liquid 4 to be used in this example has a composition as represented below.

CaCl₂.2H₂O: 10%

surfactant (Acetylenol EH: available from Kawaken Fine Chemicals): 1%

diethylene glycol: 30%

pure water: 59%

The recording head 5 used in this example has a nozzle arrangement density of 1,200 dpi, an ejection rate of 4.8 pl and a drive frequency of 12 kHz. The rate at which the recording medium 6 is fed forward at the transfer point B where the raw image on the surface layer 2 of the intermediate transfer belt 1 is transferred onto the recording medium 6 is 100 mm/sec.

The reactive liquid 4 is applied to the surface layer 2 of the intermediate transfer belt 1 by means of a roller coater with the method of the first embodiment or the second embodiment, using the inks and the reactive liquid having the above-described respective compositions and compounding ratios and an image forming apparatus according to the present invention. Thereafter, a raw image is formed by the recording head 5 and transferred onto the recording medium 6 at the transfer point B to produce a final image. The printed image is a high-quality image that is free from ink bleedings, ink penetrations and image distortions. Any ink is hardly left on the surface layer 2 of the intermediate transfer belt 1 after the raw image is transferred onto the recording medium 5 at the transfer point B.

The compounding ratio of the inks and the reactive liquid 4 can be altered according to the type of the recording medium 6 on which an image is to be formed by determining the density of at least one of the ingredients other than the coloring material of each of the ink and the density of the solid component in the reactive liquid 4 in advance so as to make them match the surface roughness of the recording medium 6. Then, as a result, as ink gets to the surface layer 2 of the intermediate transfer belt 1, the ink and the reactive liquid 4 react for coagulation and the image formed on the surface layer 2 of the intermediate transfer belt 1 represents an image transfer performance that is suitable for the surface roughness of the recording medium 6. In other words, the image formed on the surface layer 2 of the intermediate transfer belt 1 has a thickness that gives rise to an optimum image transfer performance relative to the surface roughness of the recording medium 6. Thus, a final image whose ink bleedings, ink penetrations and image distortions are maximally suppressed is formed on the recording surface of the recording medium 6 regardless of the surface roughness of the recording medium 6.

### Example 2

Each of four condensed inks (inks of four colors containing respective pigments as coloring materials) and condensed water-soluble polymer solution are mixed for use in the example. The condensed inks of this example represent respective compounding ratios same as those of Example 1, whereas the condensed water-soluble polymer solution has a compounding ratio as represented below.

styrene-acrylic acid-acrylic acid ester copolymer: 20 portions

(acid value 240, weight average molecular weight 5,000)

glycerin: 10 portions

ethylene glycol: 5 portions

surfactant: 1 portion

(Acetylenol EH (trade name): available from Kawaken Fine Chemicals)

ion exchange water: 64 portions

The recording medium 6 used in this example is wood free paper OK PRINCE available from OJI PAPER CO., LTD (basis weight 127.9 g/m²). The arithmetic average roughness of wood free paper OK PRINCE that is stored in the memory of the image forming apparatus in advance is Ra=2.32 and the corresponding ratio of each of the pigments to the water-soluble polymer is 1:3. Inks that are optimally suited for wood free paper OK PRINCE are prepared by mixing 80 grams of each of the condensed inks and 20 grams of the condensed water-soluble polymer solution and agitating the mixture.

The rate at which the recording medium 6 is fed forward at the transfer point B where the raw image on the surface layer 2 of the intermediate transfer belt 1 is transferred onto the recording medium 6 is 10, 30, 50, 100 and 500 mm/sec. Otherwise, the image forming apparatus of this example has a configuration same as that of Example 1 and hence will not be described here repeatedly.

The transfer ratio X was calculated by means of the formula represented below, where the area of the raw image formed on the surface layer 2 of the intermediate transfer belt 1 is S cm² and the area of the image left on the intermediate transfer belt without being transferred in the image transfer operation is T cm², to evaluate the image transfer performance.

transfer ratio X(%)=100×(S−T)/S

The obtained results are that the transfer ratios X are 99, 98, 99, 97 and 98% relative to the respective rates of feeding the recording medium 6 of 10, 30, 50, 100 and 500 mm/sec. Thus, high-quality images were formed on the recording medium 6.

For the purpose of comparison, an image was formed on a recording medium 6 that was also wood free paper OK PRINCE (basis weight 127.9 g/m²), using inks same as those used in Example 1 with the rate of feeding the recording medium 6 of 500 mm/sec and the image transfer performance onto the recording medium 6 was evaluated. The transfer rate was X=70% to prove that only a poor image transfer performance is achieved if appropriate inks and an appropriate reactive liquid 4 are not employed. In other words, unless the raw image on the surface layer 2 of the intermediate transfer belt 1 is not made to represent an optimal thickness for achieving an excellent image transfer performance as observed before the image gets to the transfer point B, a final image that is accompanied by ink bleedings, ink penetrations and image distortions is likely to be formed on the recording surface of the recording medium 6. Thus, a final image whose ink bleedings, ink penetrations and image distortions are maximally suppressed is formed on the recording surface of the recording medium regardless of the surface roughness of the recording medium 6 by adjusting the density of at least one of the ingredients of each of the inks for forming a raw image on the intermediate transfer belt 1 other than the coloring material, the rate of ejecting each of the inks and the density of the solid component in the reactive liquid 4 to by turn adjust the thickness of the raw image on the surface layer 2 of the intermediate transfer belt 1 that is observed before the image gets to the transfer point B.

### Example 3

The compounding ratios of the inks (four inks containing pigments of respective colors as coloring materials) used in this example are listed below.

pigments as represented below: 2 portions per ink

black: carbon black (MCF88: available from Mitsubishi Chemical)

cyan: Pigment Blue 15:3

magenta: Pigment Red 7

yellow: Pigment Yellow 74

styrene-acrylic acid-butyl acrylate copolymer: 2 portions

(acid value 120, weight average molecular weight 10, 000)

glycerin: 10 portions

ethylene glycol: 5 portions

surfactant: 1 portion

(Acetylenol EH (trade name): available from Kawaken Fine Chemicals)

ion exchange water: 80 portions

The compounding ratio of the transparent ink that is to be used in this example is represented below.

styrene-acrylic acid-butyl acrylate copolymer: 2 portions

(acid value 120, weight average molecular weight 10,000)

glycerin: 10 portions

ethylene glycol: 5 portions

surfactant: 1 portion

(Acetylenol EH (trade name): available from Kawaken Fine Chemicals)

ion exchange water: 82 portions

The recording medium 6 to be used in this example is NEW V MAT Paper (basis weight 127.9 g/m²) available from Mitsubishi Paper Mills. The arithmetic average roughness of NEW V MAT Paper (basis weight 127.9 g/m²) that is stored in the memory of the image forming apparatus in advance is Ra=1.65 and the corresponding pigment to water-soluble polymer ratio is 1:2.

To achieve the ratio, the image signal is so controlled in this example that transparent ink is ejected onto each position to which ink is ejected in such a manner that a drop of transparent ink is ejected for a drop of ink to be ejected after the application of the reactive liquid and hence at the most upstream side of the recording head.

An image was formed on a recording medium 6 in conditions same as those of Example 1 in terms of reactive liquid, intermediate transfer belt and image forming apparatus same except that the compounding ratios and the arrangements described above for this example.

The transfer ratio X as described in Example 2 was also employed for this example to evaluate the image transfer performance of this example. The transfer ratio of this example was 97%, which is a satisfactory value, and a high-quality image was formed on the recording medium 6.

### Example 4

The compounding ratios of the inks (four inks containing pigments of respective colors as coloring materials) used in this example are listed below.

pigments as represented below: 2 portions per ink black: carbon black (MCF88: available from Mitsubishi Chemical)

cyan: Pigment Blue 15:3

magenta: Pigment Red 7

yellow: Pigment Yellow 74

styrene-acrylic acid-2-ethyl hexyl acrylate copolymer: 2 portions

(acid value 160, weight average molecular weight 12,000)

glycerin: 10 portions

ethylene glycol: 5 portions

surfactant: 1 portion

(Acetylenol EH (trade name): available from Kawaken Fine Chemicals)

ion exchange water: 80 portions

The compounding ratio of the transparent ink that is to be used in this example is represented below.

styrene-acrylic acid-2-ethyl hexyl acrylate copolymer: 2 portions

(acid value 160, weight average molecular weight 12,000)

glycerin: 10 portions

ethylene glycol: 5 portions

surfactant: 1 portion

(Acetylenol EH (trade name): available from Kawaken Fine Chemicals)

ion exchange water: 82 portions

The recording medium 6 used in this example is NEW V MAT Paper (basis weight 127.9 g/m²) available from Mitsubish Paper Mills. The arithmetic average roughness of NEW V MAT Paper (basis weight 127.9 g/m²) that is stored in the memory of the image forming apparatus in advance is Ra=1.65 and the corresponding pigment to water-soluble polymer ratio is 1:2.

Three experiments were conducted in this example. To achieve the above ratio, the image signal in this example is so controlled that transparent ink is ejected onto each position to which ink is ejected in such a manner that a drop of transparent is ejected for a drop of ink to be is ejected after the application of the reactive liquid and hence at the most upstream side of the recording head (Experiment 1), between the ejection of an ink and that of another ink (Experiment 2), after all the inks are ejected and hence at the most downstream side of the recording head (Experiment 3).

An image was formed on a recording medium 6 in conditions same as those of Example 1 in terms of reactive liquid, intermediate transfer belt and image forming apparatus same except that the compounding ratios and the arrangements described above for this example.

The transfer ratio X as described in Example 2 was also employed for this example to evaluate the image transfer performance of this example. Three experiments were conducted in this example and the transfer ratios of Experiments 1, Experiment 2 and Experiment 3 of this example were respectively 97%, 97% and 100%, which are satisfactory values, and a high-quality image was formed on the recording medium 6 in each of the experiments.

An excellently transferred image was obtained in each of the experiments and the transfer ratio of Experiment 3 was slightly higher than the ratios of the other experiments. The reason for this may be that the paper surface that received transparent ink has become rich of polymer to consequently improve the adhesion of ink to the paper.

### EXPLANATION OF REFERENCE SYMBOLS

1: intermediate transfer belt
2: surface layer
3: application unit
4: reactive liquid
5: recording head
6: recording medium
7: pressure roller
10: ink density adjustment unit

### Advantages of the Invention

An image forming apparatus according to the present invention can transfer a high-quality image that is free from unnecessary penetration of ink and image distortions on the recording surface of a recording medium regardless of the surface roughness of the recording surface of the recording medium if the image is formed on the recording medium at high speed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-000966, filed Jan. 8, 2013, which is hereby incorporated by reference herein in its entirety.

What is claimed is:

1. An image forming apparatus for forming an image on a recording surface of a recording medium, the apparatus comprising:
a recording head for ejecting a liquid ink containing a coloring material;
an intermediate transfer member having a surface layer for forming a raw image thereon by means of the liquid ink ejected from the recording head;
an applicator unit for applying a reactive liquid for urging the coloring material in the liquid ink to coagulate, onto the surface layer of the intermediate transfer member prior to the formation of the raw image by the liquid ink;
a transfer unit for transferring the raw image formed on the surface layer of the intermediate transfer member onto the recording surface of the recording medium at a transfer point where the recording medium are conveyed and pressed to the intermediate transfer member; and
an adjustment unit for executing a process of adjusting a thickness of the raw image on the surface layer at an upstream side of the transfer point according to a surface roughness of the recording surface of the recording medium.

2. The apparatus according to claim 1, wherein
the adjustment unit is a density adjustment device linked to the recording head to adjust a density of at least one ingredient other than the coloring material in the liquid ink.

3. The apparatus according to claim 2, wherein
the ingredient other than the coloring material in the liquid ink includes water-soluble polymer, polymer emulsion or a mixture thereof.

4. The apparatus according to claim 1, wherein
the adjustment unit is a device for adjusting a density of solid contained in the reactive liquid.

5. The apparatus according to claim 4, wherein
the solid contained in the reactive liquid includes water-soluble polymer, polymer emulsion or a mixture thereof.

6. The apparatus according to claim 1, wherein
the adjustment unit is a device for adjusting a rate at which the recording head ejects the liquid ink.

7. The apparatus according to claim 1, wherein
the adjustment unit is a device for ejecting a liquid not containing any coloring material onto the intermediate transfer member.

8. The apparatus according to claim 1, wherein
a transfer temperature of the transfer unit is adjusted according to the surface roughness of the recording surface of the recording medium.

9. The apparatus according to claim 1, wherein
a transfer pressure of the transfer unit is adjusted according to the surface roughness of the recording surface of the recording medium.

10. The apparatus according to claim 1, further comprising:
a measurement unit arranged at an upstream side relative to the transfer point in terms of the conveyance of the recording medium to measure the surface roughness of the recording surface of the recording medium.

11. A method of forming an image on a recording surface of a recording medium by transferring a raw image formed on a surface layer of an intermediate transfer member by means of a liquid ink containing a coloring material, onto the recording surface of the recording medium, the method comprising:
a step of applying a reactive liquid for urging the coloring material in the liquid ink to coagulate, onto the surface layer of the intermediate transfer member;
a step of ejecting the liquid ink onto the surface layer of the intermediate transfer member carrying the reactive liquid applied thereto to form the raw image; and
a step of transferring the raw image formed on the surface layer of the intermediate transfer member onto the recording surface of the recording medium;
the method further comprising:
a step of executing a process of adjusting a thickness of the raw image formed on the surface layer of the intermediate transfer member according to a surface roughness of the recording surface of the recording medium.

12. The method according to claim 11, wherein
the step of executing a process of adjusting a thickness of the raw image comprises a step of adjusting a density of at least one ingredient other than the coloring material in the liquid ink.

13. The method according to claim 12, wherein
the ingredient other than the coloring material in the liquid ink includes water-soluble polymer, polymer emulsion or a mixture thereof.

14. The method according to claim 11, wherein
the step of executing a process of adjusting a thickness of the raw image is a step of adjusting a density of solid contained in the reactive liquid.

15. The method according to claim 14, wherein
the solid contained in the reactive liquid includes water-soluble polymer, polymer emulsion or a mixture thereof.

16. The method according to claim 11, wherein
the step of executing a process of adjusting a thickness of the raw image comprises a step of adjusting a rate at which the recording head ejects the liquid ink.

17. The method according to claim 11, wherein
the step of executing a process of adjusting a thickness of the raw image comprises a step of ejecting a liquid not containing any coloring material onto the intermediate transfer member.

18. The method according to claim 11, wherein
the step of transferring the raw image formed on the surface layer of the intermediate transfer member onto the recording surface of the recording medium comprises adjusting a transfer temperature according to a surface roughness of the recording surface of the recording medium.

19. The apparatus according to claim 11, wherein
the step of transferring the raw image formed on the surface layer of the intermediate transfer member onto the recording surface of a recording medium comprises adjusting a transfer pressure according to a surface roughness of the recording surface of the recording medium.

20. The method according to claim 11, further comprising:
a step of measuring a surface roughness of the recording surface of the recording medium before transferring the raw image formed on the surface layer of the intermediate transfer member onto the recording surface of the recording medium.
